(19) United States
(12) Patent Application Publication
(10) Pub. No.: US 2025/0227403 A1
(43) Pub. Date: Jul. 10, 2025

(54) SOUND REPRODUCTION DEVICE

(71) Applicant: SONY GROUP CORPORATION, TOKYO (JP)

(72) Inventors: ATSUSHI YAMAMOTO, TOKYO (JP); SHOGO SHINKAI, TOKYO (JP); HAYAMI TOBISE, TOKYO (JP); SHUN KATSUYAMA, TOKYO (JP); YUSUKE YAMADA, TOKYO (JP); TAKUMA FUKUNAGA, TOKYO (JP)

(21) Appl. No.: 18/849,515

(22) PCT Filed: Mar. 1, 2023
(86) PCT No.: PCT/JP2023/007582

§ 371 Date: Sep. 22, 2024

(30) Foreign Application Priority Data
Mar. 31, 2022 (JP) 2022-060601

(51) Int. Cl. H04R 1/08; H04R 1/10

(52) U.S. Cl. CPC H04R 1/086; H04R 1/1075

(57) ABSTRACT

Provided is a sound reproduction device which reduces air noise. The sound reproduction device includes a casing in which an opening section communicating with an inside and an outside is formed, and a microphone that is disposed in an internal space communicating with the opening section, in which a value obtained by dividing a volume of the internal space from the opening section to the microphone by an area of the opening section is 2.9 or more.

### TECHNICAL FIELD

The present disclosure relates to a sound reproduction device.

### BACKGROUND ART

In a sound reproduction device such as a headphone, what is generally called noise cancelling processing of cancelling noise collected by a feedforward microphone (hereinafter also appropriately referred to as an FF microphone) in a signal processing manner is executed (for example, see PTL 1 and PTL 2).

### CITATION LIST

### Patent Literature

### PTL 1

JP 2011-125065A

### PTL 2

JP 2020-178244A

### SUMMARY

### Technical Problem

The noise cancelling processing through use of the FF microphone can effectively cancel noise occurring outside the headphone. Meanwhile, noise occurs due to a wind entering a space in which the FF microphone is disposed being picked up by the FF microphone (pressing an FF microphone surface) and the like. Even when the noise cancelling processing through use of the FF microphone is applied to such noise, the noise has not effectively been suppressed.

One of objects of the present disclosure is to provide a sound reproduction device capable of reducing a level of noise which is caused by a wind and the like (hereinafter these pieces of noise are generally appropriately referred to as air noise) and cannot effectively be suppressed even when noise cancelling processing through use of, for example, an FF microphone is applied.

### Solution to Problem

The present disclosure is, for example, a sound reproduction device including a casing in which an opening section communicating with an inside and an outside is formed, and a microphone that is disposed in an internal space communicating with the opening section, in which a value obtained by dividing a volume of the internal space from the opening section to the microphone by an area of the opening section is 2.9 or more.

### BRIEF DESCRIPTION OF DRAWINGS

FIG. 1 is a view for describing an exterior configuration of a headphone according to an embodiment.

FIG. 2 is a view for describing the exterior configuration of the headphone according to the embodiment.

FIG. 3 is a view for schematically illustrating a wind which enters via a hole section of the headphone according to the embodiment.

FIG. 4 is a view for describing a configuration disposed in an FF microphone storage space of the headphone according to the embodiment.

FIG. 5 is a view for describing the configuration disposed in the FF microphone storage space of the headphone according to the embodiment.

FIG. 6 is a view for describing the configuration disposed in the FF microphone storage space of the headphone according to the embodiment.

FIG. 7 is a diagram for describing the configuration disposed in the FF microphone storage space of the headphone according to the embodiment.

FIG. 8 is a view for describing workings of the headphone according to the embodiment.

FIG. 9 is a graph referred to when an example of effects obtained by the headphone according to the embodiment is described.

FIG. 10 is a diagram for describing a modification example.

FIG. 11 is a diagram for describing a modification example.

FIG. 12 is a diagram for describing a modification example.

FIG. 13 is a view for describing a modification example.

FIG. 14 is a diagram for describing a modification example.

FIG. 15 is a view for describing a modification example.

FIG. 16 depicts views for describing the modification example.

FIG. 17 depicts views for describing a modification example.

FIG. 18 depicts views for describing a modification example.

FIG. 19 depicts views for describing a modification example.

FIG. 20 depicts views for describing the modification example.

FIG. 21 is a view for describing the modification example.

FIG. 22 is a view for describing the modification example.

FIG. 23 is a view for describing the modification example.

FIG. 24 is a view for describing the modification example.

FIG. 25 is a view for describing a modification example.

FIG. 26 depicts views for describing the modification example.

### DESCRIPTION OF EMBODIMENT

A description is now given of an embodiment of the present disclosure and the like with reference to the drawings. Note that the description is given in the following sequence.

### EMBODIMENT

### Modification Examples

The embodiment and the like described now are preferred specific examples of the present disclosure and a content of the present disclosure is not limited to the embodiment and the like.

### Embodiment

### Configuration Example of Headphone

In the present embodiment, a description is given of the headphone as an example of a sound reproduction device. Note that the sound reproduction device according to the present disclosure is not limited to the headphone and can be applied to other portable sound reproduction devices, for example, an earphone and a neck speaker (speaker used while the speaker is hung over the shoulder of the user).

### Overall Configuration Example

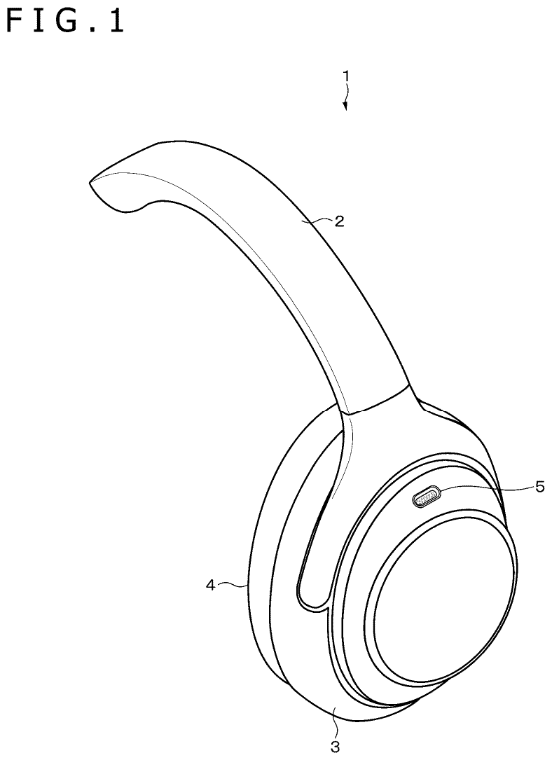

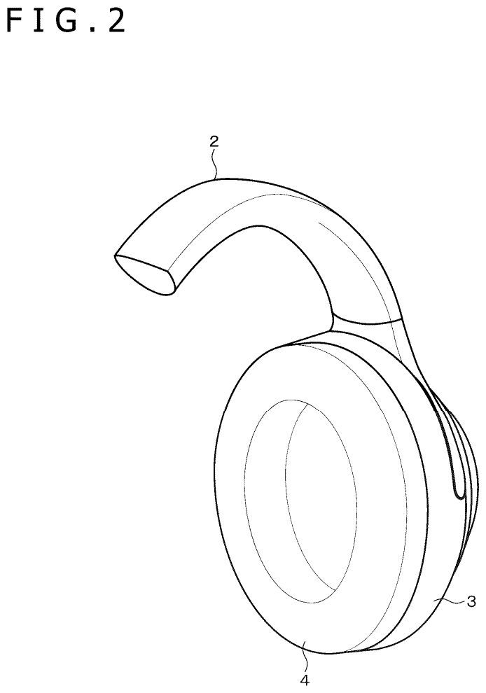

FIG. 1 and FIG. 2 are views for describing an exterior configuration of the headphone (headphone 1) according to the embodiment of the present disclosure. Note that, in FIG. 1 and FIG. 2, the headphone 1 is illustrated while a part of members is omitted for the sake of description. In FIG. 1 and FIG. 2, only a configuration on an L (Left) channel side is illustrated, but an R (Right) channel side is also substantially similarly configured. Note that the configuration on the L channel side and the configuration on the R channel side may be different from each other. For example, a configuration in a periphery of an FF microphone described later is provided to the configuration on the L channel side in the present embodiment, but may be provided to the configuration on the R channel side or may be provided to the configurations of both channels.

As illustrated in FIG. 1 and FIG. 2, the headphone 1 schematically includes, for example, a headband 2, a housing 3 which is an example of a casing, and ear pads 4. A hole section 5 in an ellipsoidal shape is formed at a position outside from the headband 2 and is in an upper portion of the housing 3.

The headband 2 is formed in a curved shape so as to follow the head portion of a wearer (user) and is in contact with the vertex of the wearer in a worn state, thereby supporting the entire headphone 1. The headband 2 includes a synthetic resin such as plastic and metal and has predetermined rigidity and elasticity, thereby having flexibility. With this configuration, the housing 3 and the ear pad 4 are pressed toward a direction of the temporal region of the wearer at the time of the wearing, so that it is possible to maintain the worn state of the headphone 1.

Note that a rubber or the like may be provided as a shock-absorbing material to a portion of an inner surface of the headband 2 which abuts against the vertex of the wearer. Moreover, a hinge may be provided such that the headphone 1 can be folded at a center when the headphone 1 is being carried. Further, a slider (not depicted) may be provided to the headband 2. It is possible to align the housing 3 and the ear pad 4 to a position opposing the ear of the wearer by sliding the slider along a guide member (not depicted) to adjust the position. With this configuration, the wearer can obtain a sense of wearing corresponding to a physical characteristic and preference of the wearer himself or herself. Meanwhile, in a case in which the headphone 1 is not used, a storage space can be reduced by bringing the slider into a contracted state.

The housing 3 serving as a casing internally has a storage space and stores a driver unit (not depicted) and the like, and the driver unit converts an electric signal to a sound wave and outputs the sound wave. The housing 3 includes, for example, a synthetic resin such as plastic. The hole section 5 which communicates with the inside and the outside of the housing 3 is formed in the housing 3. The formed position and the number of the hole sections 5 are not limited to any particular location and a specific number, respectively, and the hole section 5 is provided, for example, so as to open upward at a location close to the left side of the housing 3 with respect to the worn state of the headphone 1 as a reference. An FF microphone storage space for storing the FF microphone is formed in a space communicating with the hole section 5, which is detailed later.

The ear pad 4 is provided on a surface of the housing 3 on a side opposing the temporal region of the wearer. The ear pad 4 interposes between the housing 3 and the temporal region of the wearer, thereby functioning as a shock-absorbing member between the housing 3 and the temporal region of the wearer. That is, the ear pad 4 prevents the housing 3 which includes a hard material which unlikely deforms from causing a sense of discomfort and pain of the wearer as a result of the housing 3 coming in direct contact with the ear and the temporal region of the wearer at the wearing time of the headphone 1.

Moreover, the ear pad 4 can suppress sound omission depending on the material and hence also play a role of increasing sound quality such as reproducibility in a low sound range. Moreover, the ear pad 4 also plays a role of preventing the sound output from the driver unit from leaking to the outside. Further, the ear pad 4 also serves to block noise from the outside, thereby promoting easy-listening of the sound from the driver unit.

A sound signal is supplied to the headphone 1, and sound corresponding to the sound signal is reproduced in the headphone 1. The sound to be reproduced is any sound such as music, voice of the human, nature sound, and sound obtained by combining these sounds. The sound signal may be supplied to the headphone 1 in a wireless manner or may be supplied in a wired manner.

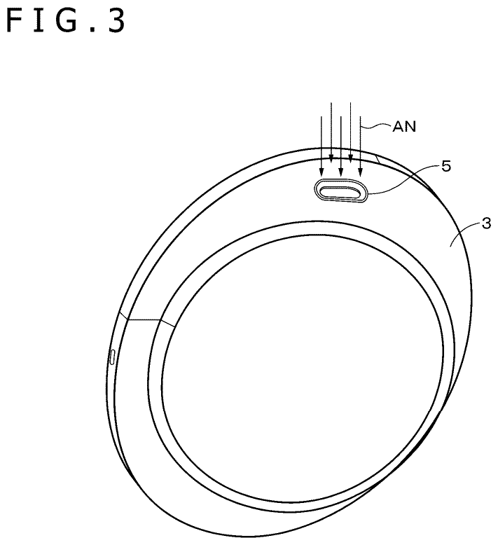

As schematically illustrated in FIG. 3, a wind and the like entering from the hole section 5 hit the FF microphone held in an internal space communicating with the hole section 5, thereby possibly causing air noise AN. As described above, such air noise AN cannot be suppressed by noise cancelling processing through use of the FF microphone. Thus, in the present embodiment, there is provided a configuration which can effectively suppress the air noise AN in the internal space communicating with the hole section 5. A description is now given of a specific example of this configuration.

### [Configuration Example of Internal Space Storing FF Microphone] (Expression for Defining Air Noise)

A brief description is now given of an equation which defines the air noise for a description of a configuration example of the FF microphone storage space. As an equation which quantitatively representing the air noise, Powell equation (Expression 1) is known.

$$\begin{matrix}[ Math . 1 ] & \\ ( {c}_{0}^{- 2} {\partial }_{l}^{2} - {∇}^{2} ) {p}^{′} = {ρ}_{0} div ( ω \times ν ) & ( 1 )\end{matrix}$$

p′ on the left side of Expression 1 represents an air noise sound pressure. w on the right side of Expression 1 represents vorticity, and v represents a speed. That is, when at least one of the vorticity or the speed can be reduced, the sound pressure (level) of the air noise can be reduced.

### Specific Configuration Example

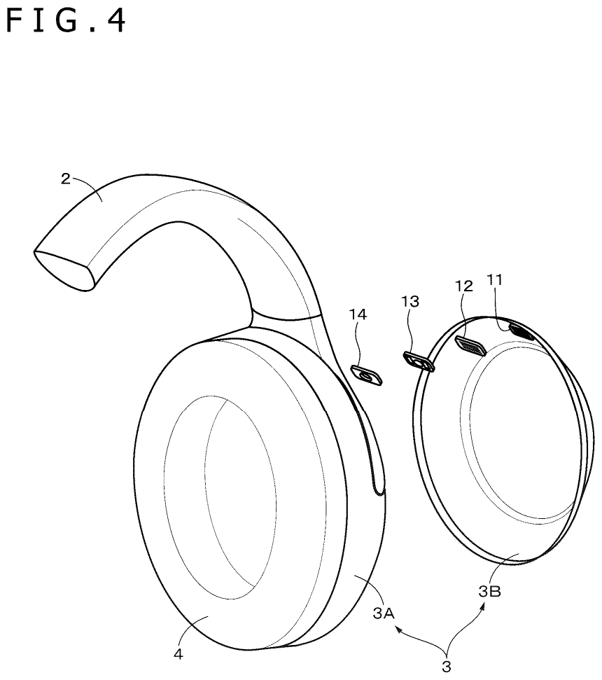

With reference to FIG. 4 to FIG. 7, a description is given of the configuration example in the FF microphone storage space according to the present embodiment. As illustrated in FIG. 4, the housing 3 includes a driver unit, a peripheral circuit thereof, a body section 3A which stores components disposed in the FF microphone storage space, and a lid section 3B attached to the body section 3A. For example, the hole section 5 is provided in the lid section 3B. As illustrated in FIG. 4, in the FF microphone storage space, schematically in a direction from the hole section 5 toward the inside of the housing 3, there are disposed an opening section 11, a mesh section 12, a flow passage division section 13, and an FF microphone holding section 14.

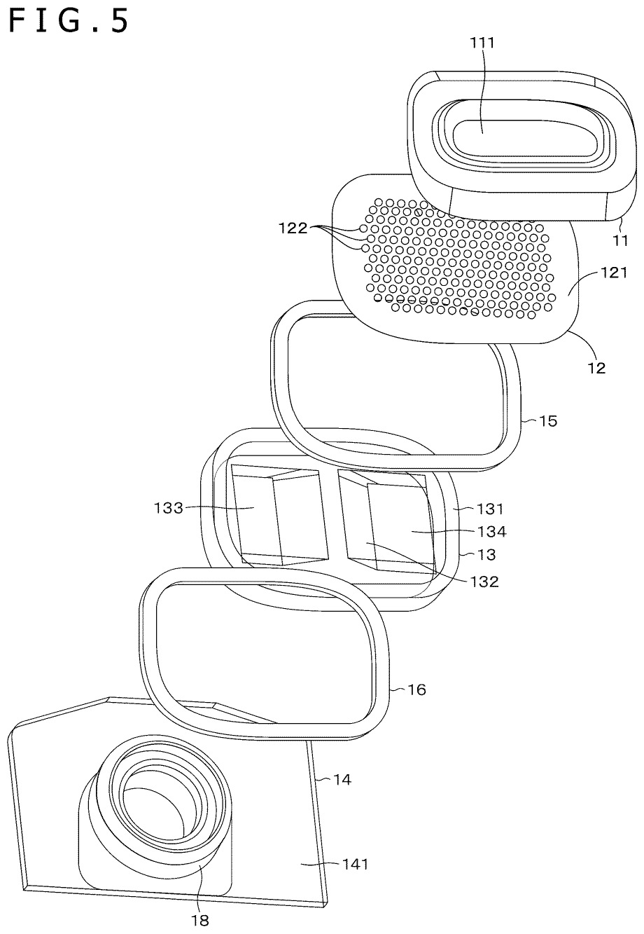

The opening section 11 includes an opening 111 in an ellipsoidal shape at the center (see FIG. 5). The opening 111 is disposed at a position corresponding to the hole section 5 of the housing 3. As illustrated in FIG. 4, the opening section 11 is attached to an inner surface of a periphery of the hole section 5 of the lid section 3B through use of adhesion, a fitting member, or the like. The opening section 11 includes resin such as plastic or metal. In the present embodiment, an opening section communicating with the inside and the outside of the housing 3 includes the hole section 5 and the opening section 11. Note that the opening section 11 may not be provided, and, in this case, the hole section 5 corresponds to the opening section which communicates with the inside and the outside of the housing 3.

On an inner side from the opening section 11 (the inside of the housing 3), the mesh section 12 is disposed. The mesh section 12 includes a base 121 in a thin plate form and a large number of mesh holes 122 provided to the base 121. The mesh section 12 includes, for example, resin. The mesh section 12 may include an elastic member such as rubber.

On an inner side of the mesh section 12, the flow passage division section 13 is disposed. In the present embodiment, between the mesh section 12 and the flow passage division section 13, a first frame-form section 15 is disposed. The first frame-form section 15 is, for example, a resin component having a frame form in a rectangular shape. The first frame-form section 15 may be omitted.

The flow passage division section 13 is a member including, for example, resin or metal. In the present embodiment, the flow passage division section 13 includes resin having a thickness of, for example, approximately several millimeters to approximately 1 centimeter. The flow passage division section 13 includes a base 131, and a mountain-form section 132 having surfaces inclined toward the lower side is formed in a vicinity of the center of the base 131. Moreover, in the base 131, two hole sections 133 and 134 are formed while the mountain-form section 132 is a border therebetween. In the present embodiment, each of the hole sections 133 and 134 is in a rectangular shape, but may be in another shape such as a circular shape or an ellipsoidal shape. The flow passage division section 13 divides a flow passage of the air (mainly the wind causing the air noise) going from the opening section 11 toward the FF microphone into two directions.

The FF microphone holding section 14 is disposed on an inner side of the flow passage division section 13. In the present embodiment, between the flow passage division section 13 and the FF microphone holding section 14, a second frame-form section 16 is disposed. The second frame-form section 16 is, for example, a resin component having a frame form in a rectangular shape. The second frame-form section 16 may be omitted.

The FF microphone holding section 14 is a member including, for example, resin or metal. In the present embodiment, the FF microphone holding section 14 includes, for example, resin. The FF microphone holding section 14 includes a base 141 in a thin plate shape. The FF microphone 18 is attached to and is held by a vicinity of the center of this base 141.

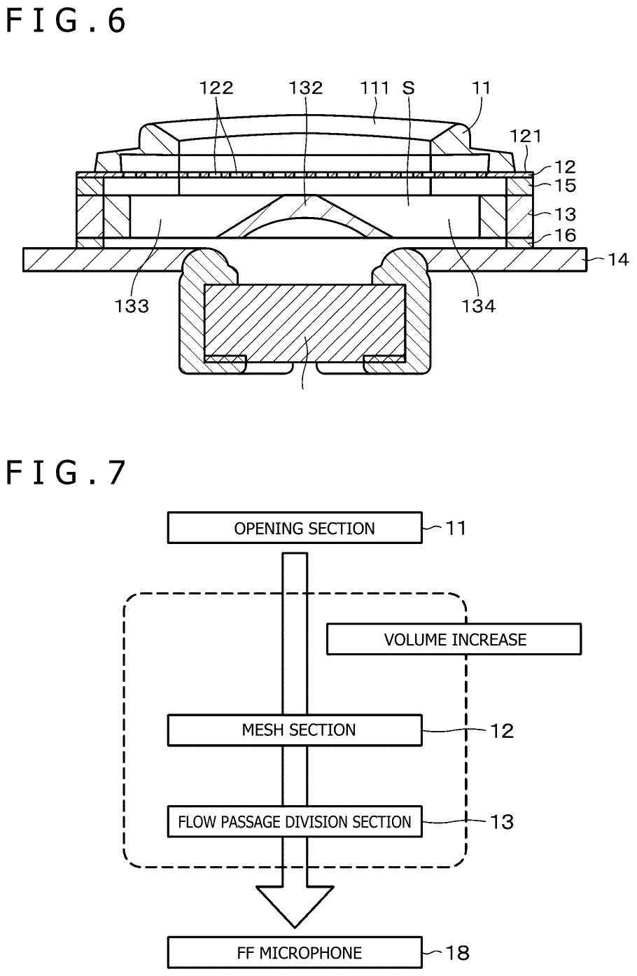

For example, an adhesive or the like is applied to a vicinity of an outer edge of each member described above, and the members are unified by adhering the members to each other. As illustrated in FIG. 6, the unified members are disposed in the FF microphone storage space S in the housing 3. The positioning of the mesh section 12, which is a relatively thin member, is promoted by interposing the first frame-form section 15. Moreover, the first frame-form section 15 and the second frame-form section 16 can be caused to function as spacer members, so that it is possible to form the flow passage of the air.

FIG. 7 is a diagram which schematically illustrates and simplifies (models) the configuration in the FF microphone storage space S. An arrow of FIG. 7 indicates a flow (wind speed vector) of the wind (which may cause the air noise AN) which has entered the FF microphone storage space S. The wind which has entered the FF microphone storage space S via the opening section 11 flows through the mesh section 12 and the flow passage division section 13 before reaching the FF microphone 18.

### (Workings)

A description is now given of workings of the headphone 1, specifically, workings of the configuration disposed in the FF microphone storage space S. In the present embodiment, a volume of the FF microphone storage space S is increased as much as possible. For example, there is provided such a setting that a value obtained by dividing a volume of an internal space from the opening section to the FF microphone 18, that is, the volume of the FF microphone storage space S by an area of the opening section is 2.9 or more. In a case in which the opening section has a configuration including the hole section 5 and the opening section 11 as in the present embodiment, the area of the opening section is defined by an area of an overlap between the hole section 5 and the opening 111 of the opening section 11. In a case of the configuration without the opening section 11, the area of the opening section is defined by the area of the hole section 5. The volume of the FF microphone storage space S is defined by a volume from a bottom section of the opening 111 to a microphone surface (end surface) of the FF microphone 18.

An effective cross sectional area with respect to the wind speed is increased by increasing the volume of the FF microphone storage space S, and hence, the speed of the wind can be reduced according to Bernoulli's theorem. That is, the speed v of Expression 1 described above can be reduced, and hence, the sound pressure of the air noise AN can be reduced.

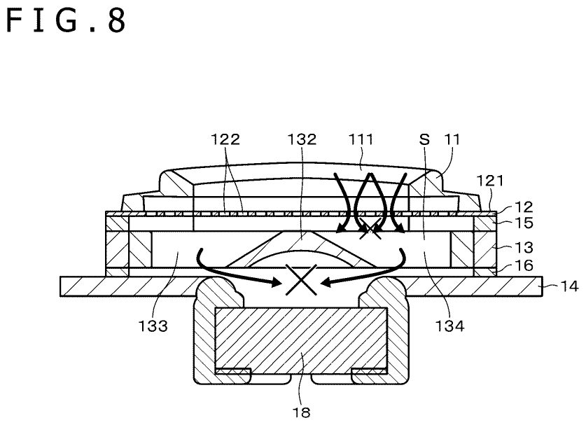

Moreover, as schematically illustrated in FIG. 8, the vorticity can be reduced by vortices of winds indicated by arrows canceling each other in a region after the passage of the mesh holes 122 of the mesh section 12. That is, the vorticity w of Expression 1 described above can be reduced, and hence, the sound pressure of the air noise AN can be reduced.

Moreover, as schematically illustrated in FIG. 8, the speed of the winds indicated by the arrows can be reduced by providing the flow passage division section 13 to divide the flow passage of the wind. Further, the speed of the wind can further be reduced by causing the wind in the divided flow passages to collide with each other from different directions (opposite directions). That is, the speed v of Expression 1 described above can be reduced, and hence, the sound pressure of the air noise AN can be reduced.

### Effects Achieved by Present Embodiment

As described above, with the configuration according to the present embodiment, the speed and the vorticity of the wind which has entered the FF microphone storage space can effectively be reduced. Thus, the level of the air noise can be reduced, and hence, sound quality of the sound reproduced by the headphone can be increased. Moreover, even in a case in which the position of the hole section 5 has a shape directed upward due to constraint of design, a certain volume or more of the FF microphone storage space is secured, and hence, the sound pressure of the air noise can be reduced.

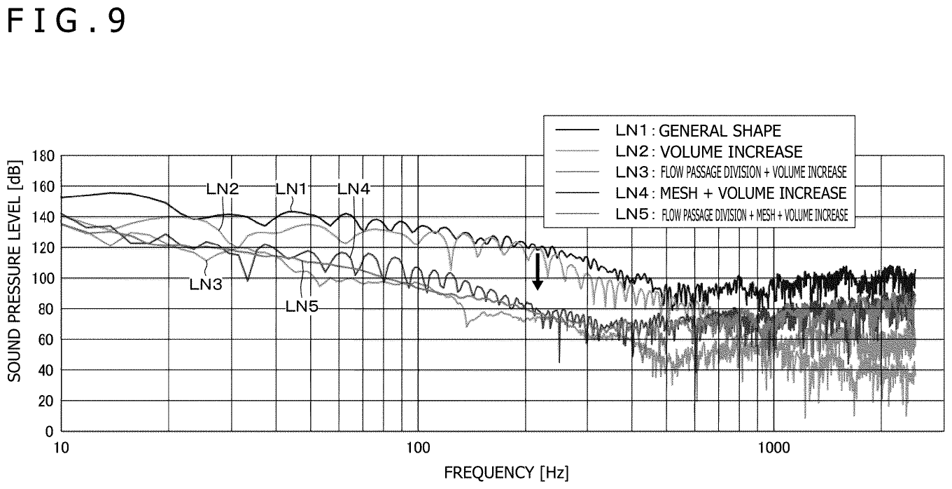

In order to confirm effects achieved by the present embodiment, simulation by a computer was executed. A graph of FIG. 9 is a simulation result and illustrates a frequency characteristic of the air noise. A vertical axis of FIG. 9 represents the sound pressure level (dB), and a horizontal axis represents the frequency (Hz). Moreover, a line LN1 of FIG. 9 indicates the frequency characteristic of the air noise in a general configuration, specifically, such a configuration that the mesh section and the flow passage division section are not provided and the wind which enters the FF microphone storage space directly reaches the FF microphone. A line LN2 of FIG. 9 indicates the frequency characteristic of the air noise in such a configuration that the volume of the FF microphone storage space is increased (by approximately five times) with respect to that of the configuration corresponding to the line LN1. A line LN3 of FIG. 9 indicates the frequency characteristic of the air noise in such a configuration that the flow passage division section is further provided to the configuration corresponding to the line LN2. A line LN4 of FIG. 9 indicates the frequency characteristic of the air noise in such a configuration that the mesh section is further provided to the configuration corresponding to the line LN2. A line LN5 of FIG. 9 indicates the frequency characteristic of the air noise in such a configuration that the mesh section and the flow passage division section are further provided to the configuration corresponding to the line LN2.

The sound pressures represented by the line LN2 to LN5 are reduced from the sound pressure represented by the line LN1. Thus, even the configuration in which the volume of the FF microphone storage space is increased or the configuration in which the volume of the FF microphone storage space is increased and one of the mesh section and the flow passage division section is provided can reduce the sound pressure of the air noise. Moreover, the configuration in which the volume of the FF microphone storage space is increased and both the mesh section and the flow passage division section are provided can reduce the sound pressure of the air noise and can further flatten the frequency characteristic of the air noise more.

### Modification Examples

The specific description has been given of the embodiment of the present disclosure, but the content of the present disclosure is not limited to the embodiment described above, and various modifications based on the technical idea of the present disclosure can be made.

### Modification Example 1

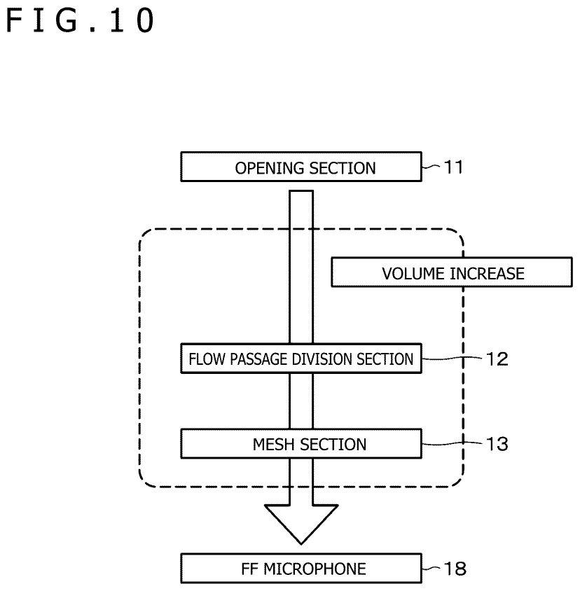

As schematically illustrated in FIG. 10, the headphone 1 may have such a configuration that, from the opening section 11 to the FF microphone 18, the flow passage division section 13 and the mesh section 12 are disposed in this order. Also according to the present modification example, similar effects to those of the embodiment are achieved.

### Modification Example 2

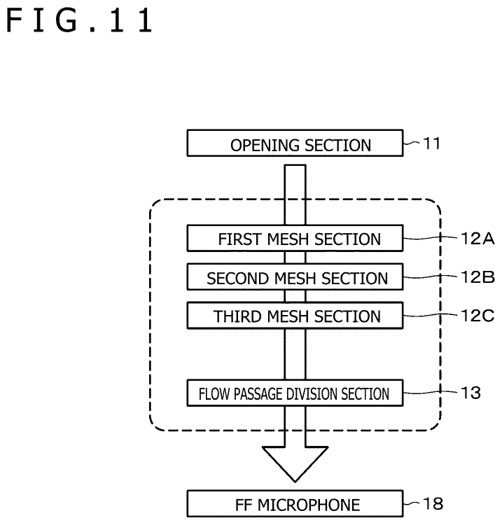

The headphone 1 may include a plurality of mesh sections. For example, as schematically illustrated in FIG. 11, the headphone 1 may include a first mesh section 12A, a second mesh section 12B, and a third mesh section 12C.

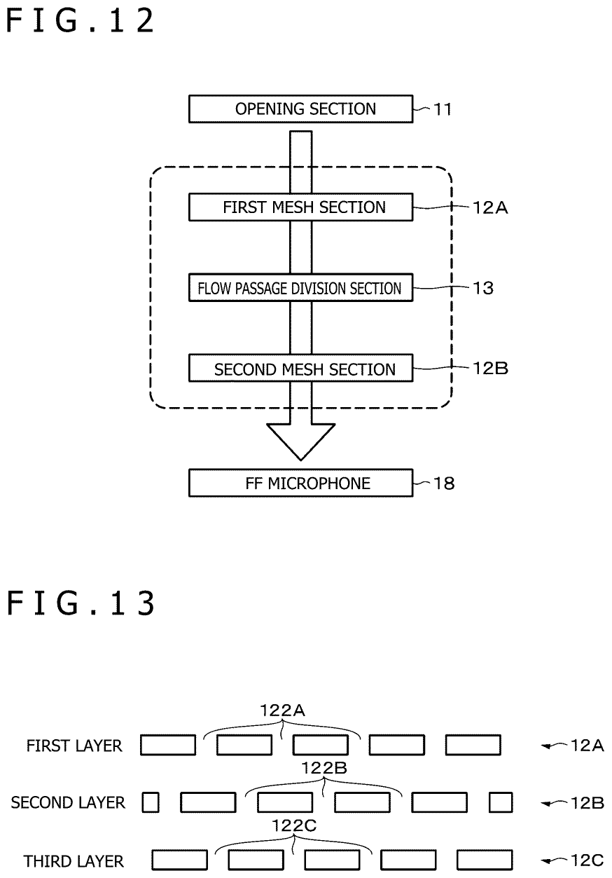

Moreover, as schematically illustrated in FIG. 12, the headphone 1 may include, for example, a configuration in which the first mesh section 12A and the second mesh section 12B are included and the flow passage division section 13 is disposed between the first mesh section 12A and the second mesh section 12B. Note that, in the case of the configuration illustrated in FIG. 11, it is preferred that, as illustrated in FIG. 13, first mesh holes 122A of the first mesh section 12A, second mesh holes 122B of the second mesh section 12B, and third mesh holes 122C of the third mesh section 12C be displaced so as to overlap with one another as less as possible (at least a part of the hole sections are at positions different from one another) in a stack direction. With this configuration, the vorticity of the wind can be reduced between the first mesh section 12A and the second mesh section 12B, and the vorticity of the wind can also be reduced even between the second mesh section 12B and the third mesh section 12C.

### Modification Example 3

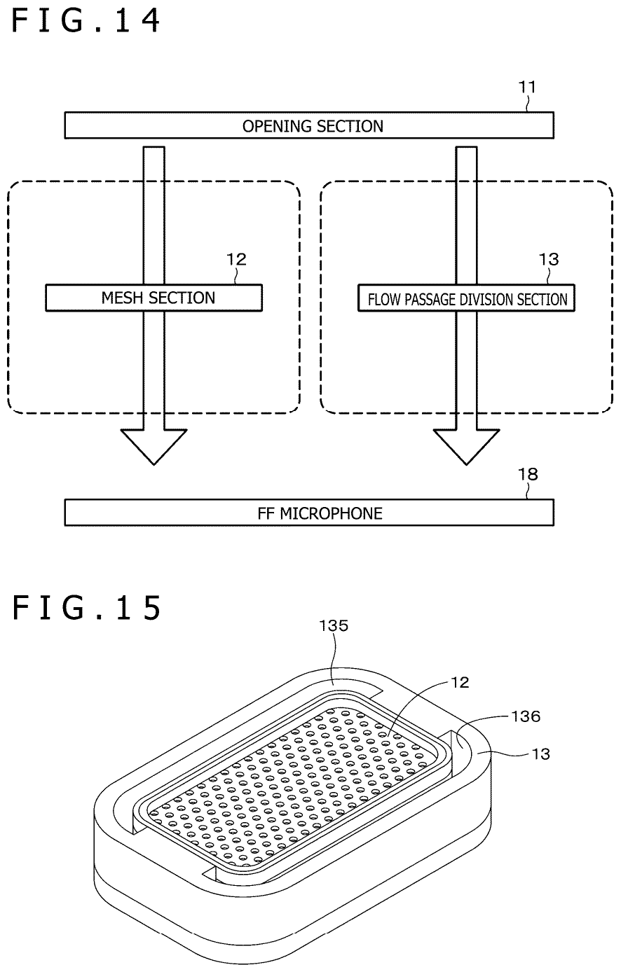

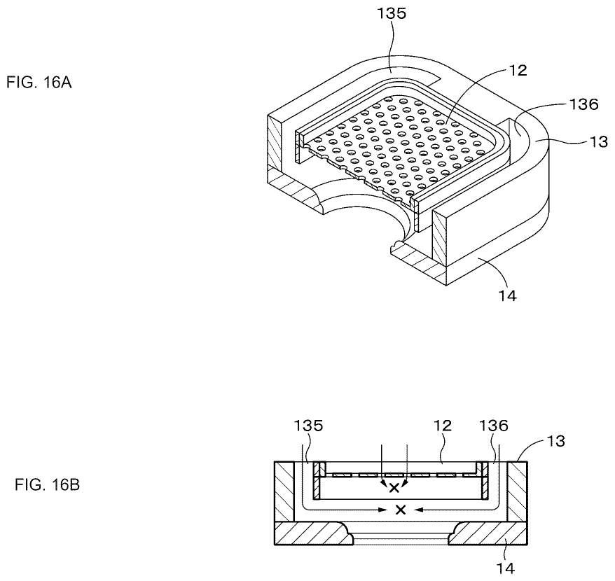

As schematically illustrated in FIG. 14, the mesh section 12 and the flow passage division section 13 may be disposed side by side in the FF microphone storage space S. FIG. 15 is a perspective view of members (unified members) disposed in the FF microphone storage space S according to the present modification example, FIG. 16A is a partial cross sectional view of these unified members, and FIG. 16B is a cross sectional view of these unified members. Note that, in FIG. 16, illustration of the FF microphone 18 is omitted. Also in other drawings, the illustration of the FF microphone 18 is appropriately omitted.

As illustrated in FIG. 15, the mesh section 12 is supported by, for example, the flow passage division section 13. The flow passage division section 13 has a hole section 135 and a hole section 136, and these hole sections are provided around the mesh section 12. Note that, in the present modification example, the opening section 11 is not provided, but the opening section 11 may be provided.

As illustrated in FIG. 16B, the wind (indicated by arrows) which has entered via the hole section 5 is reduced in vorticity in the mesh section 12. Moreover, a wind which does not pass through the mesh section 12, that is, a wind which enters from a periphery of the mesh section 12 passes through a flow passage formed such that the flow passage of the wind is divided by the flow passage division section 13 and the wind finally collide with each other, thereby being reduced in speed. Also according to the present modification example, similar effects to those of the embodiment are achieved.

### Modification Example 4

There may be a case in which the configurations which reduce the air noise described in the embodiment and the modification examples may be a configuration optimized for the wind speed such that the air noise at a predetermined wind speed can effectively be reduced. Thus, in order to efficiently reduce the air noise, the headphone 1 may have a mechanism which controls the wind speed of the wind entering the FF microphone storage space.

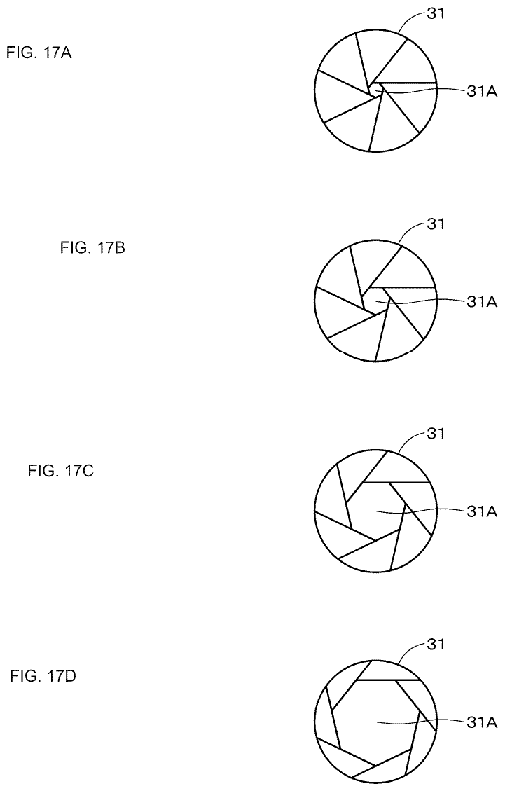

As an example of the wind speed control mechanism which controls the wind speed, a mechanism illustrated in FIG. 17A to 17D is known. The wind speed control mechanism is, for example, a diaphragm mechanism 31 which has a hole section 31A at a center and can change the size of the hole section 31A. FIG. 17A illustrates a state in which the size of the hole section 31A is most reduced, and FIG. 17B illustrates a state in which the size of the hole section 31A is slightly increased from that in the state illustrated in FIG. 17A. FIG. 17C illustrates a state in which the size of the hole section 31A is further increased from that in the state illustrated in FIG. 17B, and FIG. 17D illustrates a state in which the size of the hole section 31A is increased most. The operation of the diaphragm mechanism 31 is controlled by, for example, a control section (not depicted) or the like which integrally controls the operation of the headphone 1, and the size of the hole section 31A changes according to this control. For example, the diaphragm mechanism 31 is controlled such that the size of the hole section 31A decreases in a case in which the wind speed of the wind which has entered is low and that the size of the hole section 31A increases in a case in which the wind speed of the wind which has entered is high. With this configuration, the wind speed of the wind which has entered can be substantially constant. Note that the size of the hole section 31A is appropriately controlled such that the size is equal to or larger than a predetermined size such that the original function of the FF microphone 18 is not obstructed.

### Modification Example 5

In the embodiment described above, the mesh section 12 may not have the configuration in which the mesh holes are formed in a solid object.

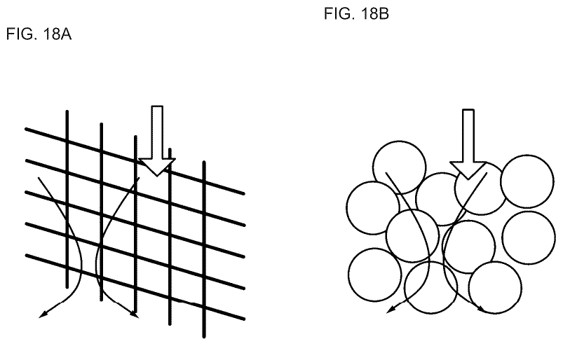

For example, the mesh section 12 may be, as illustrated in FIG. 18A, a fiber form (net form) or, as illustrated in FIG. 18B, powders (indicated as circles in FIG. 18B) fixed to such a degree that spaces are more or less provided. With this configuration, a wind schematically indicated by a thick arrow (a wind which has entered the FF microphone storage space S) is subdivided as schematically indicated by thin arrows, and hence, similar effects to those of the embodiment are achieved.

### Modification Example 6

In the embodiment described above, the flow passage division section divides the flow passage of the air directed from the opening section toward the microphone (for example, the FF microphone 18) into at least two directions, but the number of directions is not limited to two, and the flow passage of the air may be divided into three or more directions. For example, the flow passage division section 13 may be configured to include three hole sections, and the flow passage of the air may be divided into three directions.

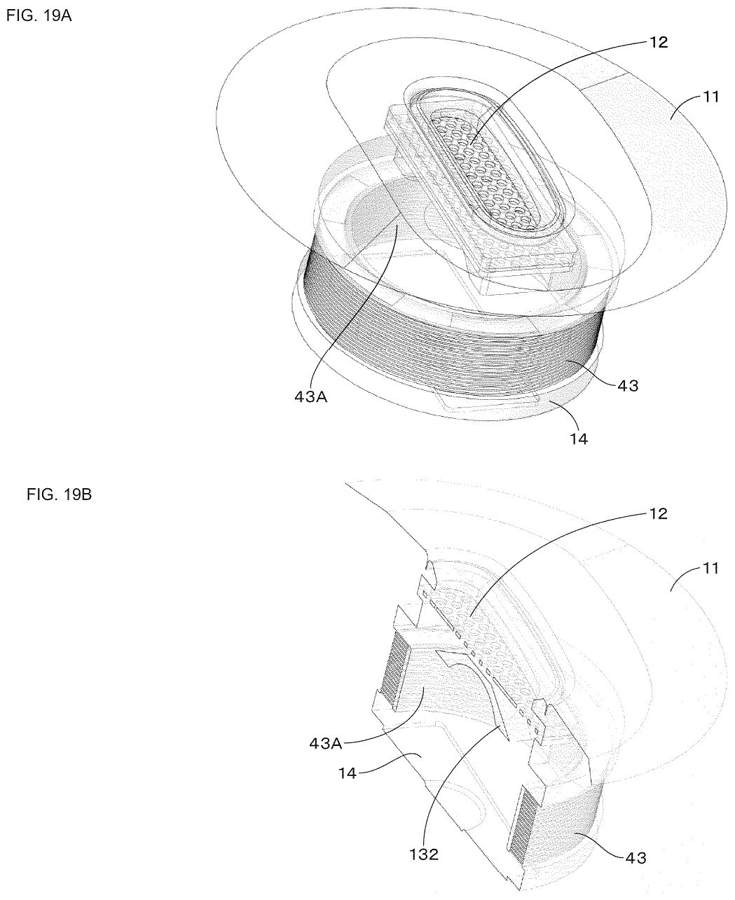

Moreover, the flow passage division section may have a shape constituting an acoustic resistance. For example, the flow passage division section may have a configuration illustrated in FIG. 19A and FIG. 19B. FIG. 19A is a perspective view for describing a configuration example of the flow passage division section (flow passage division section 43) according to the present modification example, and FIG. 19B is a partial perspective view (partial cross sectional view) for describing the configuration example of the flow passage division section 43 according to the present modification example. The flow passage division section 43 has, for example, a cylindrical shape. Moreover, the flow passage division section 43 includes a mountain-form section 132 and a plurality of groove sections 43A in an inner surface.

With the flow passage division section 43 according to the present modification example, the speed of the wind can be reduced by the mountain-form section 132. Further, the speed of the wind can further be reduced by the wind passing on the groove sections 43A. As in the present modification example, path lengths of the flow passages of the air divided by the flow passage division section 43 (a path length of a flow passage passing on the groove sections 43A and a path length of a flow passage not passing thereon) may be different from each other.

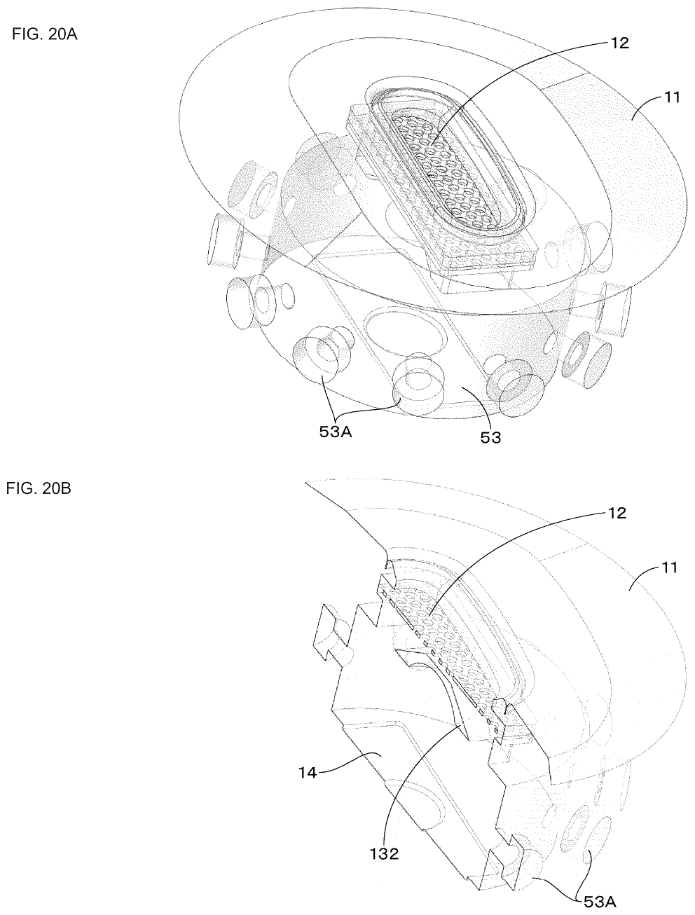

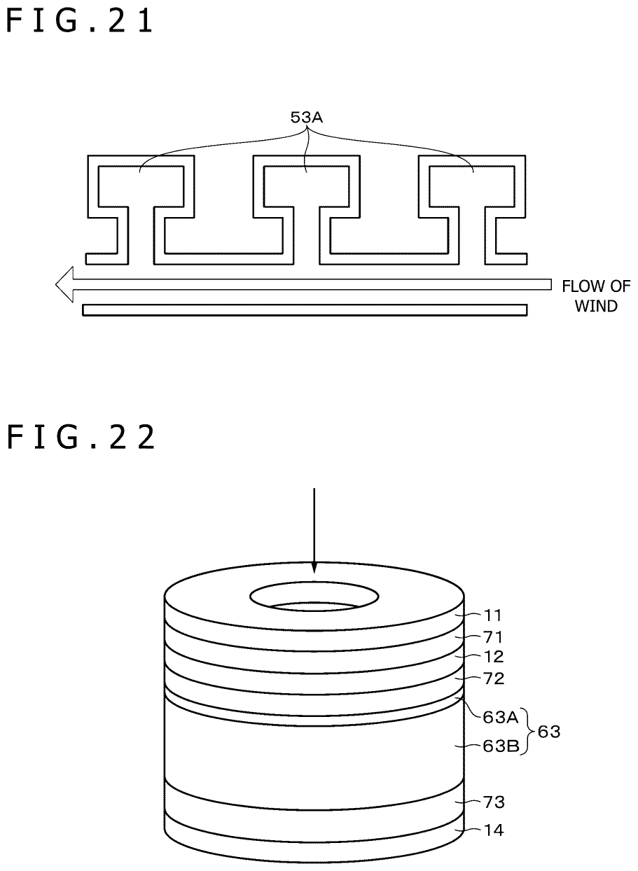

FIG. 20A and FIG. 20B illustrate another configuration example of the flow passage division section (flow passage division section 53) in the present modification example. The flow passage division section 53 is, for example, a cylindrical member and has such a shape that a plurality of closed spaces 53A is formed in an inner surface thereof. FIG. 21 is a diagram for schematically illustrating a flow of the air in the flow passage division section 53. The flow passage division section 53 according to the present modification example has such a structure that Helmholtz resonance is generated at a location serving as the flow passage of the wind. As a result, the sound pressure of the air noise can effectively be reduced at a resonance frequency.

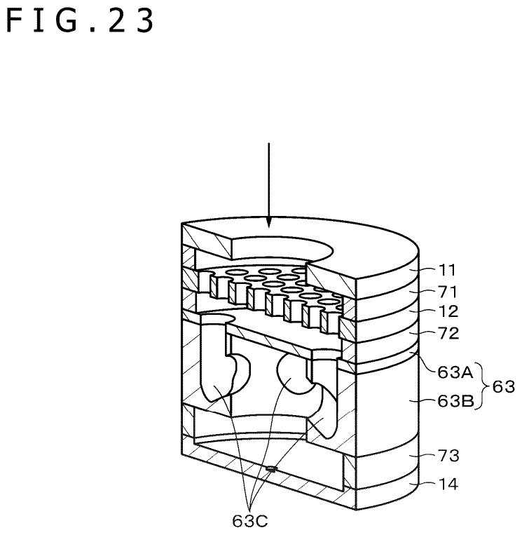

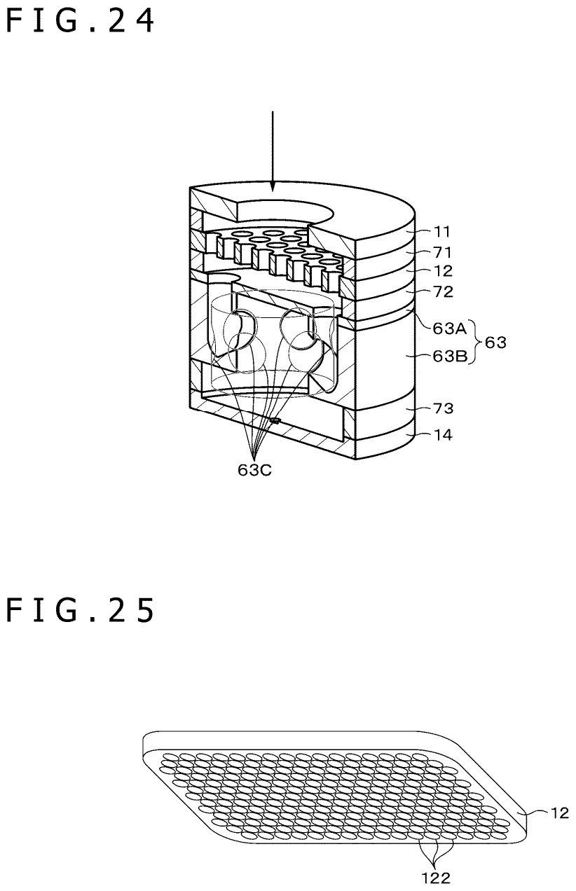

The flow passage division section may be configured so as not to have the mountain-form section. FIG. 22 is a view for describing the flow passage division section (flow passage division section 63) according to the present modification example. As illustrated in FIG. 22, the configuration stored in the FF microphone storage space has a configuration obtained by stacking the opening section 11, a first interposition member 71, the mesh section 12, a second interposition member 72, the flow passage division section 63, a third interposition member 73, and the FF microphone holding section 14. As illustrated in FIG. 23 and FIG. 24, the flow passage division section 63 includes a flat section 63A and a cylindrical section 63B. In the cylindrical section 63B, for example, six tubular sections 63C are formed (a part of the tubular sections are not illustrated in the drawing). Each tubular section 63C is in a tubular shape which has a circular opening formed in the flat section 63A as one open end (an entry side of the wind) and a circular opening formed in an inner surface of the cylindrical section 63B as another open end (an exit side of the wind). Each tubular section 63C is formed, for example, inside the cylindrical section 63B. In the present modification example, exits of a pair of the tubular sections 63C are disposed so as to oppose each other (see FIG. 24).

The speed of the wind can also be reduced by this configuration. In the present modification example, the exits of the tubular sections 63C are provided so as to oppose each other, the wind exhausted from the exits can be caused to collide with each other, and hence, the speed of the wind can effectively be reduced.

### Modification Example 7

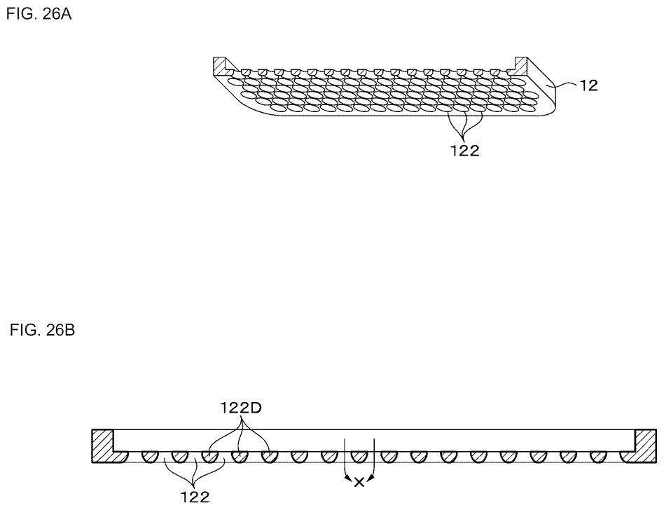

With reference to FIG. 25, FIG. 26A, and FIG. 26B, a description is given of a configuration example of the mesh section according to the present modification example. FIG. 25 is a perspective view of the mesh section 12 according to the present modification example, FIG. 26A is a partial cross sectional view of the mesh section 12 according to the present modification example, and FIG. 26B is a cross sectional view of the mesh section 12 according to the present modification example.

As illustrated in FIG. 25 and FIG. 26A, the mesh section 12 according to the present modification example also includes the mesh holes 122 similarly to the embodiment. In the present modification example, as illustrated in FIG. 26B, each of wall sections 122D which partitions the mesh holes 122 of the mesh section 12 has a tapered shape along a flow direction of the wind (direction from the opening section toward the FF microphone).

As schematically illustrated in FIG. 26B, according to the present modification example, vortices (vortices discharged from the mesh holes adjacent to each other) of the wind at the time when the wind passes through the mesh section 12 can be guided so as to collide with each other, and hence, the vortices can be caused to cancel each other. Thus, the air noise can effectively be reduced.

### Other Modification Examples

The configuration, the method, the step, the shape, the material, the numerical value, and the like mentioned in the embodiment described above are merely examples, and a configuration, a method, a step, a shape, a material, a numerical value, and the like different therefrom may be used as needed. The embodiment and the modification examples may appropriately be combined with each other.

The present disclosure can also adopt the following configurations.

(1)

A sound reproduction device including:
a casing in which an opening section communicating with an inside and an outside is formed; and
a microphone that is disposed in an internal space communicating with the opening section,
in which a value obtained by dividing a volume of the internal space from the opening section to the microphone by an area of the opening section is 2.9 or more.
   (2)

The sound reproduction device according to (1),
in which a mesh section that includes multiple hole sections and a flow passage division section that divides a flow passage of air going from the opening section toward the microphone to at least two directions are disposed between the opening section and the microphone in the internal space.
   (3)

The sound reproduction device according to (2),
in the mesh section and the flow passage division section are disposed in this order from the opening section toward the microphone.
   (4)

The sound reproduction device according to (3),
in which another mesh section different from the mesh section is disposed between the flow passage division section and the microphone from the opening section toward the microphone.
   (5)

The sound reproduction device according to (2),
in which the flow passage division section and the mesh section are disposed in this order from the opening section toward the microphone.
   (6)

The sound reproduction device according to (2),
in which a plurality of the mesh sections is stacked, and
the plurality of mesh sections is stacked such that the hole sections of the mesh sections are partially different from one another in position in the stacking direction.
   (7)

The sound reproduction device according to any one of (2) to (6),
in which each of the multiple hole sections of the mesh section has a shape tapered in a direction from the opening section toward the microphone.
   (8)

The sound reproduction device according to (2),
in which the mesh section and the flow passage division section are disposed side by side in a direction substantially orthogonal to the direction from the opening section toward the microphone.
   (9)

The sound reproduction device according to any one of (1) to (8), further including:
a control mechanism that controls a flow rate of air flowing into the casing via the opening section.
   (10)

The sound reproduction device according to (2),
in which flow passages of the air divided by the flow passage division section are different from one another in path length.
   (11)

The sound reproduction device according to (2),
in which the flow passage division section includes a cylindrical member including a plurality of closed spaces formed in an inner surface.
   (12)

The sound reproduction device according to any one of (1) to (11),
in which the sound reproduction device includes any one of a headphone, an earphone, and a neck speaker.

### REFERENCE SIGNS LIST

1: Headphone
3: Housing
11: Opening section
12, 12A, 12B, 12C: Mesh section
13, 53, 63: Flow passage division section
18: FF microphone
31: Diaphragm
122: Mesh hole
S: FF microphone storage space

1. A sound reproduction device comprising:
a casing in which an opening section communicating with an inside and an outside is formed; and
a microphone that is disposed in an internal space communicating with the opening section,
wherein a value obtained by dividing a volume of the internal space from the opening section to the microphone by an area of the opening section is 2.9 or more.

2. The sound reproduction device according to claim 1,
wherein a mesh section that includes multiple hole sections and a flow passage division section that divides a flow passage of air going from the opening section toward the microphone to at least two directions are disposed between the opening section and the microphone in the internal space.

3. The sound reproduction device according to claim 2,
wherein the mesh section and the flow passage division section are disposed in this order from the opening section toward the microphone.

4. The sound reproduction device according to claim 3,
wherein another mesh section different from the mesh section is disposed between the flow passage division section and the microphone from the opening section toward the microphone.

5. The sound reproduction device according to claim 2,
wherein the flow passage division section and the mesh section are disposed in this order from the opening section toward the microphone.

6. The sound reproduction device according to claim 2,
wherein a plurality of the mesh sections is stacked, and
the plurality of mesh sections is stacked such that the hole sections of the mesh sections are partially different from one another in position in the stacking direction.

7. The sound reproduction device according to claim 2,
wherein each of the multiple hole sections of the mesh section has a shape tapered in a direction from the opening section toward the microphone.

8. The sound reproduction device according to claim 2,
wherein the mesh section and the flow passage division section are disposed side by side in a direction substantially orthogonal to the direction from the opening section toward the microphone.

9. The sound reproduction device according to claim 1, further comprising:
a control mechanism that controls a flow rate of air flowing into the casing via the opening section.

10. The sound reproduction device according to claim 2,
wherein flow passages of the air divided by the flow passage division section are different from one another in path length.

11. The sound reproduction device according to claim 2,
wherein the flow passage division section includes a cylindrical member including a plurality of closed spaces formed in an inner surface.

12. The sound reproduction device according to claim 1,
wherein the sound reproduction device includes any one of a headphone, an earphone, and a neck speaker.
